(19) United States
(12) Patent Application Publication
(10) Pub. No.: US 2017/0249364 A1
(43) Pub. Date: Aug. 31, 2017

(54) APPARATUS, METHOD AND COMPUTER-READABLE MEDIUM THAT ASSIGNS A MEASURE TO AN ITEM AND ASSITS LOCATION OF AN ITEM

(71) Applicant: Nada Hisham ATTAR, Boston, MA (US)

(72) Inventor: Nada Hisham ATTAR, Boston, MA (US)

(21) Appl. No.: 15/054,782

(22) Filed: Feb. 26, 2016

(51) Int. Cl. G06F 17/30; G06F 3/0482

(52) U.S. Cl. CPC G06F 17/30528; G06F 17/30867; G06F 17/30345; G06F 17/30554; G06F 3/0482

(57) ABSTRACT

A server, method, and computer-readable medium, the server including circuitry configured to receive a first item and a plurality of factors from an external device, prompt the external device to send a first set of factors, and a first set of ratings and a first set of weights to indicate importance of each of the first set of factors in locating the first item, compute a first weighted rating based on the first set of ratings and the first set of weights to generate a threshold that captures the importance of each of the first set of factors, conduct a search in a database of the server based on the first weighted rating, the first set of ratings and the first set of weights to locate at least one entity offering the first item, and transmit, via a network, the at least one entity to display on the external device.

### GRANT OF NON-EXCLUSIVE RIGHT

This application was prepared with financial support from the Saudi Arabian Cultural Mission, and in consideration therefore the present inventor(s) has granted The Kingdom of Saudi Arabia a non-exclusive right to practice the present invention.

### BACKGROUND

Field of the Disclosure

This application relates generally to improvements in an apparatus, method, and computer-readable medium that allow assigning a measure to an item and determining different locations of an item.

Description of the Related Art

People search for entertaining and interesting activities to perform on a regular basis, over the weekend, holidays, birthday parties, or other social and personal care activities. Typically, the social activities involve visiting a restaurant and ordering a favorite item on a menu, visiting a bar and ordering a favorite drink, visiting dance clubs, shopping, or the like. The personal care activities can involve going to a salon for a haircut, pedicure, manicure, massage, etc. For people with children, regular activities can involve searching for a babysitter, and sending children to playgroups, training classes, etc.

One or more activities can be offered at a particular place by one or more entity. As such, searching for a particular activity of high quality that offers fun and satisfaction can be a tedious task. Typically, a choice is based on the reviews of an entity or a place, word of mouth, social networking websites, reviews provided on different websites such as YELP, FACEBOOK, TWITTER, LINKEDIN, advertising, etc.

Typically, the review available is an overall review of the place or the entity with a narration of events that occurred at a personal level or in a social gathering. The reviews are based on a few of the items on a menu offered by the entity, or the quality of service offered rather than each item on the menu. Further, unfairly harsh critical reviews based on a single experience are commonly seen. As such, one does not know where he or she can get an item based on personal preference of rating factors when the review is for the overall entity or a place in general.

### SUMMARY

According to an embodiment of the present disclosure, there is provided a server. The server includes circuitry configured to receive, via a graphical user interface, a first item and a plurality of factors associated with the first item from an external device, and prompt, via the graphical user interface, the external device to send a first set of factors selected from the plurality of factors, and a first set of ratings and a first set of weights corresponding to the first set of factors to indicate importance of each of the first set of factors in locating the first item. The circuitry is further configured to compute a first weighted rating based on the first set of ratings and the first set of weights assigned to the first set of factors to generate a threshold that captures the importance of each of the first set of factors, conduct a search in a database of the server based on the first weighted rating, the first set of ratings and the first set of weights associated with the first set of factors to locate at least one entity offering the first item, and transmit, via a network, the at least one entity to display on the external device to allow selection of an entity, from among the at least one entity, that exceeds the threshold of the importance of each of the first set of factors.

Further, according to an embodiment of the present disclosure, there is provided a method. The method includes receiving, using a processing circuitry, a first item and a plurality of factors associated with the first item from an external device, and prompting, using the processing circuitry, the external device to send a first set of factors selected from the plurality of factors, and a first set of ratings and a first set of weights corresponding to the first set of factors to indicate importance of each of the first set of factors in locating the first item. The method further includes computing, using the processing circuitry, a first weighted rating based on the first set of ratings and the first set of weights assigned to the first set of factors to generate a threshold that captures the importance of each of the first set of factors, conducting a search, using the processing circuitry, in a database of a server based on the first weighted rating, the first set of ratings and the first set of weights associated with the first set of factors to locate at least one entity offering the first item, and transmitting, via a network, the at least one entity to display on the external device to allow selection of an entity, from among the at least one entity, that exceeds the threshold of the importance of each of the first set of factors.

Further, according to an embodiment of the present disclosure, there is provided a non-transitory computer-readable medium which stores a program which, when executed by a computer, causes the computer to perform the method, as discussed above.

The forgoing general description of the illustrative implementations and the following detailed description thereof are merely exemplary aspects of the teachings of this disclosure, and are not restrictive.

### BRIEF DESCRIPTION OF THE DRAWINGS

A more complete appreciation of the disclosed embodiments and many of the attendant advantages thereof will be readily obtained as the same becomes better understood by reference to the following detailed description when considered in connection with the accompanying drawings, wherein:

FIG. 1 is a block diagram of a system according to an exemplary embodiment of the present disclosure.

FIG. 2 is an exemplary interface of a user device according to an exemplary embodiment of the present disclosure.

FIG. 3 is flow chart for assigning a measure to an item according to an exemplary embodiment of the present disclosure.

FIG. 4A illustrates a first screen of an interface of a RSS app according to an exemplary embodiment of the present disclosure.

FIG. 4B illustrates a second screen of an interface of a RSS app according to an exemplary embodiment of the present disclosure.

FIG. 4C illustrates a third screen of an interface of a RSS app according to an exemplary embodiment of the present disclosure.

FIG. 5 is a detailed block diagram of a server according to an exemplary embodiment of the present disclosure.

FIG. 6 is a detailed block diagram of a user device according to an exemplary embodiment of the present disclosure.

### DETAILED DESCRIPTION

In the drawings, like reference numerals designate identical or corresponding parts throughout the several views. Further, as used herein, the words “a”, “an” and the like generally carry a meaning of “one or more”, unless stated otherwise. The drawings are generally not drawn to scale unless specified otherwise or illustrating schematic structures or flowcharts.

Furthermore, the terms “approximately,” “proximate,” “minor,” and similar terms generally refer to ranges that include the identified value within a margin of 20%, 10% or preferably 5% in certain embodiments, and any values therebetween.

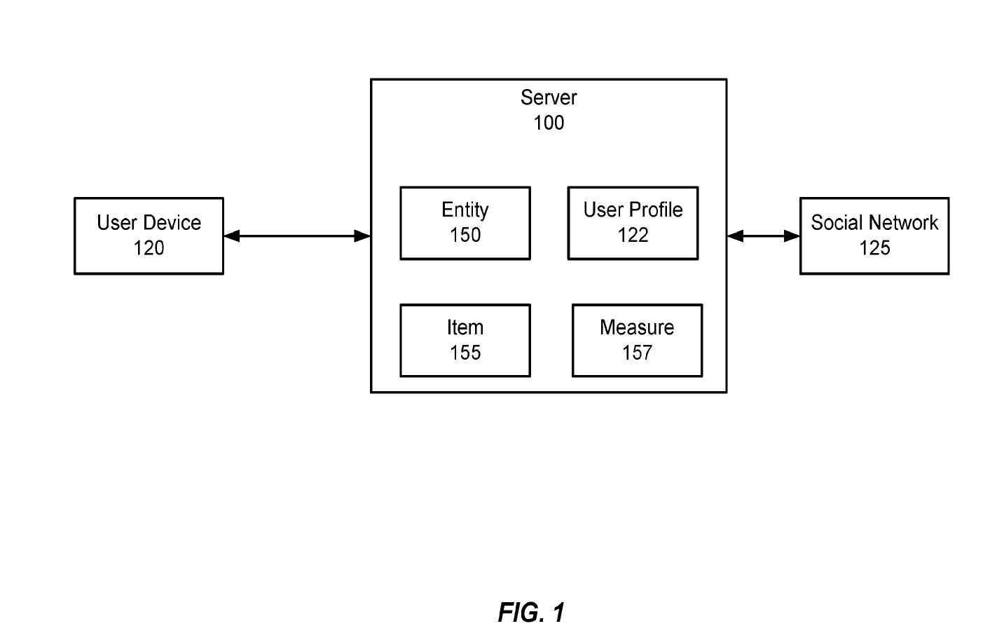

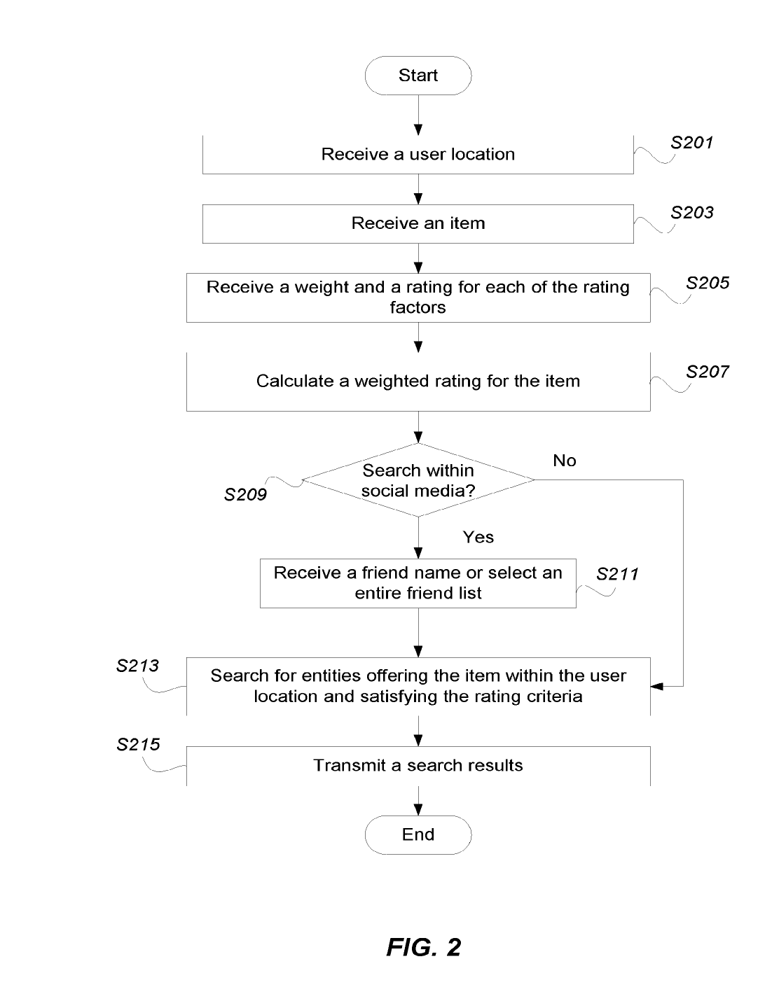

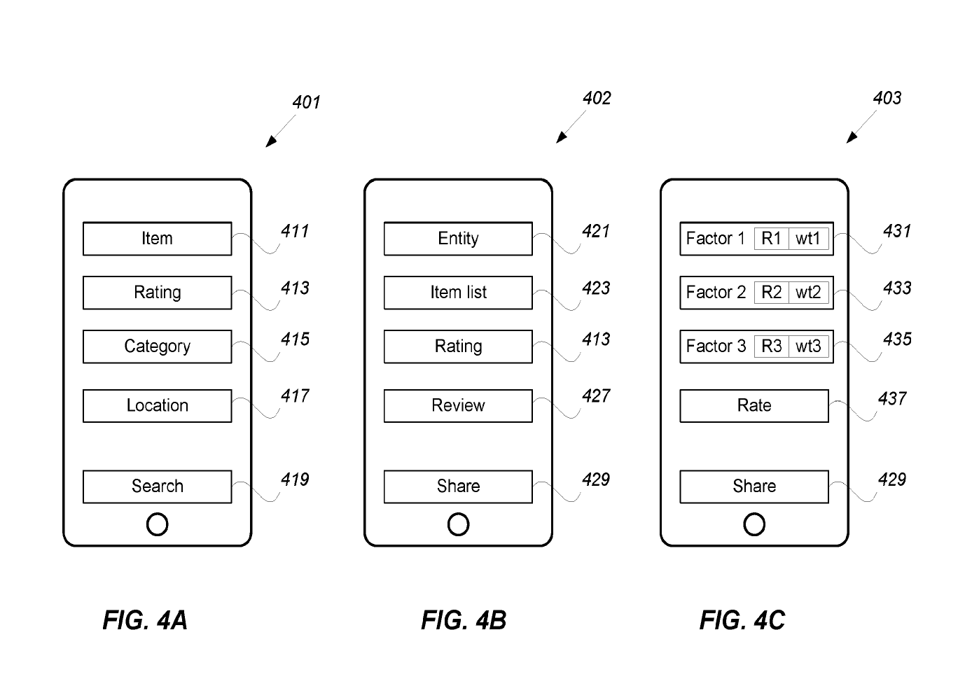

FIG. 1 illustrates a block diagram of a server-centric system for locating an item and sharing reviews according to an embodiment of the present disclosure. The system includes a server 100, a user device 120, and a social network 125 (stored at one or more servers). The server 100 stores information related to an entity 150, an item 155 offered by the entity 150, a review 157 of the item 155, and a user profile 122. The server 100 acts as a central information database that contains past as well as real-time information related to a user, the entity 150, and the item 155. The server 100 processes and communicates information to different users such as a customer at a restaurant via the user device 120. The user device 120 can send and receive information from the server 100 using a rating, sharing, and searching app (referred as “RSS app” hereafter) executed on the user device 120. An app is software executed on a device. Devices can be programmed via software to provide the functionalities discussed in the present disclosure, for example, functions described with respect to FIGS. 2, 3 and 4A-4C. When executed on a device such software is referred to as an “app”. For example, the RSS app can be executed on the use device 120 or the server 100. An interface of the RSS app used to access the server 100 is explained with respect to FIGS. 4A-4C.

The user device 120 can be an electronic device such as a smartphone, a tablet, a desktop or a laptop. The user device 120 executes user command via RSS app to extract information required by the user.

The user profile 122 can include information related to the user of the system. For example, the user profile 122 can include a user id, password, demographic, age, education, profession, link to one or more social network accounts, preferences such as a location, demographic, rating factors, or similar elements that can be used as filter criteria. The user profile 122 can be stored in a memory of the server 100. The user can be a part of one or more of the social network 125 and his/her social network account(s) can be linked to the user account of the RSS app, thus enabling sharing of information via the RSS app.

The entity 150 can be a person, a vendor, a corporation, or any other professional selling one or more items to the user. The entity 150 can be located in a geographical location similar to the user, or virtually on the internet. For example, the entity 150 can be a restaurant, a cafe, a spa, a gym, an airport, a baby sitter, a merchant store, a salon, a consultant, or a theater. The information related to the entity 150 can be stored in a memory of the server 100.

The item 155 refers to one or more items offered by the entity 150. The item 155 can be a food item, a service, a product, or the like offered by the entity 150. For example, the items can be a cheese burger, a kabab, a mango lassi, pasta, a pizza, fish, a crab cake, a boxing class, a message, an eye cream, a haircut, a pedicure, a manicure, etc. The item 155 information can be stored in a memory of the server 100.

The measure 157 can be assigned to each item 155 to determine how much the user likes (or favors) or dislikes (not favors) the item 155. The measure 157 can be quantified using a scale, for example, a scale from 1 to 10, where 1 indicates highly disliked, and 10 indicates highly liked. The measure 157 can be a rating from 1 to 5, a weight corresponding to a rating factor, etc. The rating can indicate a favorability of the rating factor corresponding to the item 155, while the weight can indicate an importance of the rating factor corresponding to the item 155. In one embodiment, the measure 157 can also be a narrative of an experience with respect to the item 155. The measure 157 can be assigned to one or more rating factors associated with the item 155. Further, a consolidated measure can be calculated using the measures related to the rating factors of the item 155. The measure 157 can be computed by the server 100 and stored in a memory of the server 100.

FIG. 2 is a flow chart for searching for an item according to an embodiment of the present disclosure. The process starts when the server 100 receives a signal from the user device 120, for example, to retrieve information. In step S201, the server 100 receives a location from the user device 120. The location can be determined using the GPS sensor on the user device 120. In one embodiment, a user can enter the location in the form of a postal or a zip code, area, city, state, street address, etc. in RSS app executed on the user device 120 and transmit the location to the server 100. For example, the location can be a 10 mile radius around a current location or around a postal or a zip code.

In step S203, the server 100 can receive an item a user wishes to locate at a particular location. The item can be transmitted from the user device 120 via an interface of the RSS app. For example, a user can enter the item name or code on a screen 401, in FIG. 4A. The item can be a food item, a service, a product, or the like offered by the entity 150. For example, the items can be a cheese burger, kabab, mango lassi, pasta, pizza, fish, crab cake, a boxing class, a message, an eye cream, haircut, pedicure, manicure, etc.

In step S205, the server 100 can receive rating factors and corresponding weights and ratings. A rating factor is an attribute that can be rated (or measured) to determine the quality of an item, service, or to quantify how much an item is liked or disliked by the user. Different sets of rating factors can be pre-determined for each item offered by a type of an entity such as a restaurant, a spa, a massage parlor, etc. For example, for food items of a restaurant, the rating factors can be service quality, ambience of the restaurant, taste, equipment or tool used for cooking, serving, or eating, time spent on a service (e.g., taking an order, bringing the item, billing, etc.), waiting time (e.g., to get a table, to receive food after ordering, to receive check, etc.), whether food items were recommended by a friend or not, etc.

A weight is a measure used to determine the importance or preference of a particular rating factor in determining an overall rating. The weight can be a number from 0 to 10, for example. The user can assign the weight to each rating factor using an interface of the RSS app such as screen 403 in FIG. 4C.

As discussed earlier, the rating factors can be predetermined. For example, for a food item such as sushi or chicken kabab, the rating factors can be taste, service quality, ambience, food quality, and friend likes (i.e., whether a particular friend likes the food item, or a total number of friends that like the food item). The user can assign a weight of 10 for taste, 5 for service quality, 2 for ambience, 8 for food quality, and 6 for friend likes. Further, each rating factor can have a rating based on a scale (e.g., from 0 to 10). For example, a rating of 5 can be assigned by default to each rating factor. In one embodiment, a rating can be chosen based on the weight of each rating factor, such that a higher rating is assigned to a rating factor carrying higher weight compared to other rating factors. For example, ratings (on an exemplary scale from 0 to 5) chosen for different rating factors can be 5 for taste, 2.5 for service quality, 1 for ambience, 4 for food quality, and 3 for friend likes.

In step S207, the server 100 computes a weighted rating based on information from the step S205. The weighted rating can be calculated by taking a sum of the product of the weights and rating for each rating factor and dividing the sum by the total weight. For example, using the weights and rating from step 205, the weighted rating will be (10*5+5*2.5+2*1+8*4+6*3)/(10+5+2+8+6), which is approximately equal to 3.69. Further, the weighted rating can be rounded up or down. For example, the weighted rating can be rounded up to 4.

In step S209, the server 100 determines whether a search must be performed on the social media. The determination can be based on a choice made by the user, while creating the user profile 122 that is stored in the memory of the server 100. In one embodiment, the user may be prompted via the RSS app executed on the user device 120 to permit the use of social media accounts. The user choice can be transmitted from the user device 120 to the server 100. If not permitted, the process leads to step S213.

If the searching on social media is permitted, the server 100 receives a friend's name or a list of friends, in step S211. The friend name can be transmitted to the server 100 via the RSS app executed on the user device 120. In one embodiment, a friend list can be selected from the social media account(s) of the user profile 122 stored in the memory of the server 100.

In step S213, the server 100 searches for entities offering the item within the user location and satisfying the rating criteria. The search is performed in a database of the server 100 containing the entities, the list of items offered and other related information. In addition, search may be performed within the social media of the friend(s) received in step S211. The server 100 can search the comments section, likes, dislikes, or other similar section where user posts their experience on the social media.

In step S215, the server 100 transmits the search results obtained in step S213 to an external device such as the user device 120. The search results can include a list of entities or a message indicating an error, no entities found or other relevant messages. The search results can also include other related information that can be viewed by the user on the user device 120. The related information can include a weighted rating of each restaurant, a delivery time rating associated with each restaurant, and a distance of each restaurant from a location of the user. The search result can be transmitted wireless over a network. The search results can be transmitted to the display controller of the user device 120 to enable a user to view and browse through the search results. In addition, the search results can also be stored in the database of the user profile 122 or the memory of the server 100.

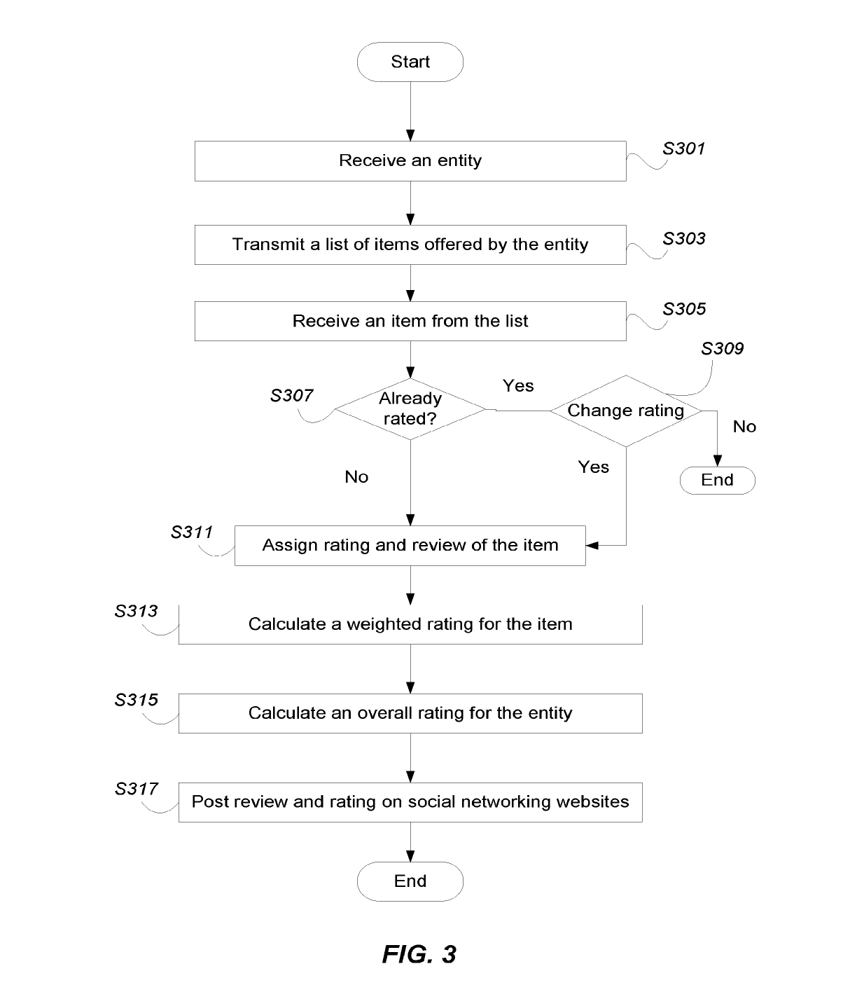

FIG. 3 is a flow chart for assigning a measure to an item of an entity according to an embodiment of the present disclosure. The process starts when the server 100 receives a signal from the user device 120 to rate an item of an entity. For example, the user may wish to rate an item (e.g., delux sushi) at the Sumo Japanese restaurant visited recently. In step S301, the server 100 receives an entity (e.g., Sumo Japanese restaurant). The entity can be enter in the user device 120 via the RSS app, for example using an entity button 421 of the interface displayed in the screen 402 in FIG. 4B. The entity can be transmitted wireless over the network from the user device 120 to the server 100.

In step S303, the server 100 retrieves and transmits a list of items offered by the entity (e.g., Sumo Japanese restaurant) of step S301 from the database of the server 100. For example, the list can be a menu including items such as miso soup, clear soup, salads, edamame, gyoza, chicken tempura, shrimp sumai, chirashi sushi, regular sushi, delux sushi, triple delight sushi, etc. If the entity is a salon, the list of items can be haircut, pedicure, manicure, etc. and other related information. If the entity is a babysitter, the list of items can be name of the babysitters and other related information.

In step S305, the server 100 receives an item from the list of items of step S303. A particular item entered in the user device 120 via the RSS app using the screen 402, where the user can select or type the name of the item from the list of items of the step S303. For example, the server 100 receives the item delux sushi, which the user selects and the user device 120 transmits the selection to the server 100.

In step S307, the server 100 checks if the item was already rated. The server 100 can search the user profile 122 stored in the database of the server 100 to check if a rating is available for the item (e.g., rating for delux sushi). If the rating is already assigned to the selected item (e.g., delux sushi), the server 100 determines whether the rating needs to be changed, in step S309. The rating can be changed based on a user input provided via the RSS app and transmitted by the user device 120 to the server 100. For example, if a rating for the item is found, the server 100 can transmit a message to the user device 120 that allows the user to change the rating via the interface of the RSS app.

If a rating for the item is not already assigned or if the rating needs to be changed, the server 100 assigns rating and review of the item, in step S311. The user can assign the rating and the weight to each rating factor using an interface of the RSS app such as screen 403 in FIG. 4C. For example, if the user wishes to rate the item delux sushi, the user can assign a weight (e.g., on a scale from 0 to 10) as follows: 10 for taste, 0 for service quality, 0 for ambience, 8 for food quality, and 10 for friend likes. Similarly, the user can assign a rating (e.g., on a scale from 0 to 10) as follows: 8 for taste, 8 for service quality, 9 for ambience, 10 for food quality, and 8 for friend likes.

In step S313, the server 100 computes the weighted rating for the item (e.g., delux sushi). The weighted rating can be calculated by taking a sum of the product of the weight and rating for each rating factor and dividing the sum by a total weight. For example, using the weights and rating from step 311, the weighted rating for delux sushi will be (10*8+0*8+0*9+8*10+10*8)/(10+0+0+8+10), which is approximately equal to 8.57. In one embodiment, the weighted rating can be rounded up to 9 or rounded down to 8 or 8.5 depending on the rounding adopted or programmed. The weighted rating computed in step S313, and the weights and the rating factors considered while calculating the weighted rating can be stored in the database of the server 100.

In step S315, the server 100 can compute an overall rating or weighted rating for the entity. For example, the overall rating can be based on total number of visitors or total number of reviews or ratings available for the entity. The overall rating can be calculated using an average (or weighted average) of different rating factors such as an average of service quality rating, an average of price rating, (i.e., rating related to price of an item-a price that is too high can be rated low, a reasonable price for the taste or quality of food can be rated high, a price that is low can be rated high, or the like) and other rating factors available. For example, a restaurant (e.g., the Sumo Japanese restaurant) can be rated based on rating factors such as taste, service quality, and price. Consider the Sumo Japanese restaurant had a total of 500 reviews and rating, the average of 500 taste rating is 9, the average of 500 service rating is 6, and average of 500 price rating is 9. Then the overall rating of the entity can be (9+6+9)/3, which is equal to 8. In one embodiment, the weighted rating can be calculated, where weights can be assigned by a user based via the RSS app.

In one embodiment, the rating factors for an entity can be predetermined or a user can select the rating factors from a list of rating factors available. Based on the selected rating factors the overall rating of an entity should be calculated. The rating factors can be selected via the RSS app executed on the user device 120 and transmitted to the server 100. In one embodiment, the server 100 can consider all the ratings provided by the visitors for each rating factor or omit some ratings of the rating factor; particularly the ratings for which the weight of the rating factor is low (e.g., weight less than 3). As such, the total ratings available for each rating factor can vary. For example, if there are 500 ratings for taste, 200 for service quality, and 450 for price, then the average of each rating factor is based on the respective number of ratings. Thus, the average of taste will be based on 500 ratings, the average of service quality will be based on 200 ratings, and the average of price will be based on 450 ratings.

Further, as the rating factors can be selected by a user, the overall rating of the entity can vary for each user. Thus, each user can have a different overall rating of the same entity instead of one overall rating for all users. The ratings factors can vary for different users for several reasons. For example, some users may prefer a take-out option, while some users may prefer dine-in option. As such, for the take-out users, the service quality and the ambience may not be important. On the other hand, for dine-in users, the service quality and the ambience may be important. For example, referring to table 1, the overall rating of a restaurant (e.g., Sumo Japanese restaurant) for user 1, user 2, and user 3, is 8.2, 6.2, and 7.5 respectively.

| User 1 | | User 2 | | User 3 | |
|---|---|---|---|---|---|
| | Avg. | | Avg. | | Avg. |
| Rating Factors | rating | Rating Factors | rating | Rating Factors | rating |
| Taste | 8.5 | Taste | 8.5 | Taste | 8.5 |
| Food quality | 7 | Ambience | 5 | Service quality | 5 |
| Price | 9 | Service quality | 5 | Price | 9 |
| Overall rating | 8.2 | Overall rating | 6.2 | Overall rating | 7.5 |

The overall ratings are computed in step S315; the weights and the rating factors considered while calculating the overall rating can be stored in the database of the server 100.

In step S317, the server 100 posts the review and rating on the social networking websites. The instruction to post the review can be transmitted to the server 100 from the user device 120 via the RSS app.

A user can search and rate different type of items and entities on the server 100 via the RSS app executed on the user device 120. For example, consider a user named Emily liked a hand lotion with lavender fragrance that was bought from L'Occitane, and she rated the item in her profile. After several months, she does not remember the store from which she purchased the lavender lotion. She can search in her own profile using the item name “lotion” or “lavender lotion” and the server 100 can retrieve the entity information from the database.

In another example, consider Robert visited San Francisco and tried a burger in a small local restaurant. He rated the burger in his own profile. Also, he integrated this information on his social networks (e.g., FACEBOOK and TWITTER). After three years, John, a friend of Robert searches for a place that has a good burger and matches Roberts's taste. John can't remember the name of the place, or town of that restaurant. So, John requests to search in Robert's social network for an item “burger” for location “San Francisco” and the item pops up with the details of the restaurant.

In another example, the search capability can help find or discover new items and experiences. Someone can search for “spinning class” rated by “undergrad students”, a “Chicken Tajin” rated by a particular group of people (for example, those that have lived in Morocco, are enthusiasts of this particular food, etc.), a “babysitter” rated by a particular group of people (for example, people with 2 or more children, people living in a particular area, people of a particular age group, etc.), etc.

Integration with the social network (e.g., news feed of FACEBOOK) for every user allows their friends to know the items they have rated instead of only places they visited. They can comment under the item that the user made. For example, an integration with a social network's news feed for Tina says: Tina likes “spinning class” at “Boston sport club” or Ruby likes “Mango Lassi” at “Indian Kabab”.

FIGS. 4A-4C illustrate an interface of the RSS app according to an embodiment of the present disclosure. The RSS app can include a plurality of screens, each screen providing an interface to allow a user to input information or an interface to display information. In one embodiment of present disclosure, three screens 401, 402, and 403 are presented as an example. In FIG. 4A, a screen 401 illustrates an interface that allows a user to enter an item to be searched and corresponding search criteria. The screen 401 includes an item button 411, a rating button 413, a category button 415, a location button 417, and a search button 419. The item button 411 allows a user to input an item (e.g., delux sushi) that the user wishes to search. The rating button 413 allows the user to enter a rating, which can be used as filter criteria to narrow the search. The rating can be a number, for example, from 0 to 10. In one embodiment, the rating button 413, when activated, opens a different screen such as screen 403, where each of the rating factors and the associated weight and rating can be input.

The category button 415 allows the user to optionally enter a particular category to search such as a particular age group of people, those that hold themselves as having a particular cultural interest/knowledge, aficionados of a particular activity (spin class, babysitting, etc.) or food item (pizza, pasta, cheese, wine). Such categories may be listed under the user profile 122, and every user may have a particular category that he or she believes to have particular expertise in. The category button 415 can be used to enter an optional filter criterion. The category button 415 can be particularly helpful to find more authentic entities such as a restaurant, or culturally similar choices. For example, in one scenario, a person who has visited or has lived in Italy may know more about the Italian cuisine than someone who has not. Such distinction can help a user decide between picking one restaurant over another.

The location button 417 allows the user to enter a particular location, where the item needs to be located. The location can be a postal or a zip code, city, state, a current location, a 10 mile radius around a current location, etc.

Once the item information is entered using the item button 411 and the filter criteria using the buttons 413, 415, and 417, a search can be performed by activating the search button 419. Activating the search button 419, sends a signal to the server 100 while transmitting all the input parameters from the buttons 411, 413, 415, 417 and 419 to the server 100. The input parameters are used by the server 100 to determine a list of entities as illustrated in FIG. 2.

In FIG. 4B, the interface on screen 402 allows the user to rate and post review for a particular item consumed, used, browsed or purchased by the user at an entity. The screen 402 includes buttons such as an entity button 421, an item list button 423, the rating button 413, a review button 427, and a share button 429. The entity button 421 allows the user to enter an entity (e.g., Sumo Japanese restaurant) visited by the user. The item list button 423 allows the user to select an item (e.g., deluxe sushi) offered by the entity (e.g., Sumo Japanese restaurant). When the user activates the item list button 423, the server 100 transmits a list of items offered by the entity (e.g., Sumo Japanese restaurant) as discussed with respect to step S303 in FIG. 3. The rating button 413 performs similar function as discussed earlier with respect to screen 401.

The review button 427 button allows the user to enter a review comment such as a narrative of his/her experience consuming the selected item (e.g., deluxe sushi) at the entity (e.g., Sumo Japanese restaurant). Optionally, the share button 429 can be included to allow sharing of the rating and review of the item or entity on social media.

In FIG. 4C, the interface on screen 403 allows the user to enter a rating and weights for a set of rating factors. The screen 403 includes buttons for each rating factor, for instance, a rating factor 1 button 431 includes a rating field R1 and a weight field wt1, a rating factor 2 button 433 includes a rating field R2 and a weight field wt2, a rating factor 3 button 435 includes a rating field R3 and a weight field wt3. Further, the screen 403 includes a rate button 437 that sends a signal to the server 100 to compute a weighted rating as discussed with respect to step S313 or S315 in FIG. 3. Optionally, the share button 429 can be included to allow sharing of the rating on a social media.

The process of locating an item and rating an item can be illustrated by the following example. The example considers two different users (a first user U1 and a second user U2), who want to locate two different food items in the same city at a different time of day. The first user U1 wants to locate a food item such as a “pizza” within a city such as “Alexandria, Va.” for take-out at lunch time and the second user U2 wants to locate a food item such as “pasta” within the city “Alexandria, Va.” for dine-in at dinner time. Conventional searching approaches are based on overall rating of the restaurant that will output a similar list of restaurants, since both food types can be found in an Italian restaurant. On the other hand, using the RSS app each of the first user U1 and the second user U2 will receive a different list of restaurants as the searching is based on rating factors specific to each particular user. For example, the taste of the item and the delivery time may be factors that are more important to the first user U1, and the first user U1 may not care for other factors such as the ambience and the service quality of the restaurant, as the first user U1 does not intend to visit (or dine-in) the restaurant. On the other hand, the ambience and the service quality of the restaurant may be more important for the second user U2, and the second user U2 may not care about other factors such as delivery time, as the second user U2 intends to dine-in. The second user U2 may which to stay longer at the restaurant and enjoy longer conversations, and thus be more interested in a restaurant that has a nicer ambience.

The first user U1 can input the item “pizza” using the item button 411 displayed on the screen 401 and the location “Alexandria, Va.” using the location button 417 displayed on the screen 401 of the RSS app executed on the user device 120. The item “pizza” and the location “Alexandria, Va.” can be transmitted from the user device 120 to the server 20 (i.e., steps S201 and S203). The server 20 can be programmed to recognize the type of item (e.g., food type) and retrieve the rating factors corresponding to a food type item from a database of the server 20.

For example, the rating factors for a food type of item can be the taste, ambience of the restaurant where the food item is available, price, delivery time, service quality, friendliness, waiting time, staff attire, cleanliness, etc. The rating factors can be transmitted from the server 20 to the user device 120 of the first user U1. As the first user U1 wants to order take-out, the first user U1 can select a first set of rating factors such as taste, price, and delivery time using the rating button 413 on screen 401 of the user device 120. The remaining rating factors may not be of interest to the first user U1. On the other hand, the second user U2 can select a second set of rating factors such as the taste of the item, the ambience, the service quality, and the cleanliness of the restaurant (as the second user U2 would like to dine-in).

Upon selection of the first set of rating factors, the first user U1 can assign weights and rating to the first set of rating factors on screen 403. For example, the rating and weight for each of the first set of rating factors can be as follows: taste (8, 8), price (5, 7), delivery time (10, 10), where the first number in the parenthesis is the rating and the second number is the weight. Note that the rating/weight is assigned via the user device 120 based on personal preference of the first user U1. In this particular case, delivery time is most important to user U1 as this has been given a rating/weight of (10,10). The rating and the weights for each of the first set of rating factors is transmitted to the server 20 (i.e., the step S205). The server 20 calculates a first weighted rating of the item “pizza” (i.e., step S207). For example, the first weighted rating of the item “pizza” can be calculated as (8*8+5*7+10*10)/(8+7+10), which is approximately equal to 6. Similarly, a second weighted rating of the item “pasta” can be 8, which is calculated using the second set of rating factors for the second user U2. Optionally, the first user U1 may want to omit searching in review posts of a friend on social media related to the item “pizza” in “Alexandria, Va.” (i.e., steps S209 and S211). However, the second user U2 may decide to follow rating posted on the social media by friends who have lived in or visited Italy (e.g., John and Amy), since these people would know more about the Italian cuisine, or simply that the second user U2 trusts John and Amy's choice of restaurant or have similar taste profile as the second user U2.

Based on the first weighted rating, the server 20 searches in the database for entities having the first weighted rating greater than 6, where the first weighted rating is calculated using the first set of rating factors (i.e., in step S213). The server 20 can find a list of entities satisfying the aforementioned criteria. For example, a list of entities can be names of restaurants such as Nero, Al a Lucia, Vaso's Kitchen, Formaggio, Red Rocks, DOMINOS, PIZZAHUT, Mikes's pizza, etc.

On the other hand, based on the second weighted rating of the second user U2, the list of restaurants can be Al a Lucia, Vaso's Kitchen, Red Rocks, Geranio Restaurant, Italian Gourmet, etc. Clearly, the first user U1 and the second user U2 receive different lists of restaurants. Restaurants such as DOMINOS, PIZZAHUT, Mike's Pizza and Formaggio were omitted from the list of restaurants for the second user U2 as the second set of rating factors include the ambience and the service quality and do not include the delivery time. The difference in the list of restaurants can also indicate that some restaurants may be more suited for take-out type orders rather than dine-in type options. The list of restaurants is a part of the search results that are transmitted from the server 20 to the user device 120 (in step S215).

The search results not only include the list of restaurants but may also include other related information that can be viewed by the first user U1 on the user device 120. The related information can include a weighted rating of each restaurant, a delivery time rating associated with each restaurant, and a distance of each restaurant from a location of the first user U1. Based on the search results presented to the first user U1, the first user U1 can decide to order the “pizza” from the restaurant “Formaggio”, since “Formaggio” not only satisfies the first set of rating factors associated with a particular item i.e., “pizza”, but also may be closest compared to other restaurants.

Subsequently, after the experience with the particular selected restaurant, the first user U1 may want to rate “pizza” purchased at the restaurant “Formaggio”, while the second user U2 may want to rate “pasta” purchased at “Vaso's Kitchen”. Conventionally, a rating application allows a user to assign an overall rating of the restaurant and does not reflect the factors related to an item purchased that caused the user to assign the overall rating. The RSS app, on the other hand, not only captures the rating factors but also provides flexibility to specify a set of factors for rating an item purchased at the restaurant. Furthermore, the RSS can determine a user specific overall rating of the restaurant based on the rating factors chosen by the user rather than just the overall rating of the restaurant.

To rate the item “pizza” ordered from “Formaggio” via the RSS app executed on the user device 120, the first user U1 inputs a name of the restaurant “Formaggio” using the entity button 421 of the screen 402. The name of the restaurant “Formaggio” is transmitted from the user device 120 and received by the server 20 (in step S301). The server 20 can retrieve, from the database, a list of items on a menu offered by “Formaggio” and transmit the list of items to the user device 120 (in step S303). The first user U1 can access the list of items by activating the item list button 423 of the screen 402 and select “pizza”. The item “pizza” is transmitted from the user device 120 and received by the server 20 (in step S305). The server 20 then determines if the item “pizza” purchased from “Formaggio” was already rated by the first user U1. If the item was already rated, the first user U1 is prompted to either change or not change the rating on the RSS app executed on the user device 120. If the item “pizza” at “Formaggio” was not rated or the first user decides to change the rating, the first user U1 can activate the rating button 413 on the screen 402, which allows the first user U1 to select the first set of rating factors. Upon selecting the first set of rating factors, the RSS app brings up the screen 403, which allows the first user U1 to enter the rating and weights for each of the first set of rating factors. The rating and weights for each of the first set of rating factors is transmitted from the user device 120, which is received by the server 20. Based on the first set of rating factors and corresponding ratings and weights, the server 20 calculates a weighted rating of the item “pizza” as discussed earlier. Further, the server 20 retrieves all the ratings and weights corresponding to the first set of rating factors assigned in the past by other users and stored on the database of the server 20.

The ratings and weights by the other users are used to calculate an overall weighted rating of the restaurant “Formaggio”, as discussed earlier with reference to step S315. Thus, based on the first set of rating factors, the overall weighted rating of the restaurant “Formaggio” may be 8, since “Formaggio” may be highly rated for delivering orders on-time. On the other hand, based on the second set of rating factor of the second user U2, the overall weighted rating of the restaurant “Formaggio” may be 4, since “Formaggio” may be poorly rated for ambience and service quality. As such, the same restaurant “Formaggio” can have different ratings specific to a user as provided by the RSS app, as opposed to conventional rating applications that provide a single overall rating to all users. The RSS app also allows integration with the social media, as the first user U1 and the second user U2 may decide to post ratings of respective items on social media.

In one embodiment, the sever 20 can generate a suggestion report that includes suggested items other than “pizza” based on the first set of rating factors related to the item “pizza” purchased at lunch time, for example. To generate the suggestion report, the server 20 can search the database for other food items such as a burger, soup, etc. that are commonly consumed during lunch and that satisfy the first set of rating factors. The suggested items need not have been purchased by the first user U1 in the past. The suggested items can be stored in the first user U1's profile and can be accessed in the future. Hence, the first user U1 can try a variety of items that he/she may not have consumed in the past as a result of this generated report.

In one embodiment, the RSS app can generate a similarity report based on the first set of rating factors. The similarity report compares the first set of rating factors (or the second set of rating factors) of the first user U1 (or the second user) with at least one friend (on social media) who has a similar set of rating factors, and a similar set of ratings and weights. The first set of rating factors (or the second set of rating factors) need not be applied to the same item such as “pizza” or “pasta”. As such, the similarity report can help the first user U1 (or the second user U2) to identify other friends who have similar rating preferences. Further, the similarity report can display a list of items that were purchased by the friend(s) with similar rating preferences but not purchased by the first user U1 (or the second user U2). For example, the similarity report can include a list of friends, with each friend having a list of the items such as burger, pizza, sandwich, etc. Thus, the first user U1 (or the second user U2) can follow a particular friend's food choice to discover new food items.

In one embodiment, the server 100 may generate an alert in response to one or more users agreeing with a particular rating of another user or rating an item or having the same preferences as another user. In other words, in following the aforementioned example, if there is compatibility (i.e., similar taste given by similar ratings) between the first user U1 and the second user U2, the server 100 may alert user U1 of being compatible with user U2 (and/or vice versa).

The generated alert may take many forms (i.e., text via short message service (SMS), email, FACEBOOK, etc., or a messaging protocol specific to the RSS app, audio, video, etc.) The alert may also be in the form of report that combines various types of information. For example, the alert generated for user U1 may include a notification that user U2 also rated “pizza” at a particular restaurant in a similar fashion as user U1, that user U2 has also given the same rating for “pizza” at another restaurant which user U1 may not have visited. Thus, the alert may include additional suggestions for user U1 on places to visit based on user U2's experience.

The alert may also include a suggested category for user U1 to join. For example, the server 100 may determine that user U1 is a pizza aficionado, and thus include a suggestion to join a particular group of pizza aficionados. The server 100 may include a link embedded as part of the alert on which user U1 may click to join this group. Note that, upon joining such group, the server 100 would add this “category” to user U1's profile 122.

This alert may be sent by the server via a network to the user device 120. The server 100 may cause the alert to be displayed on the user device 120 (for example, via the RSS app). The user U1 may then be prompted to join particular groups or connect with particular users (in this case, user U2).

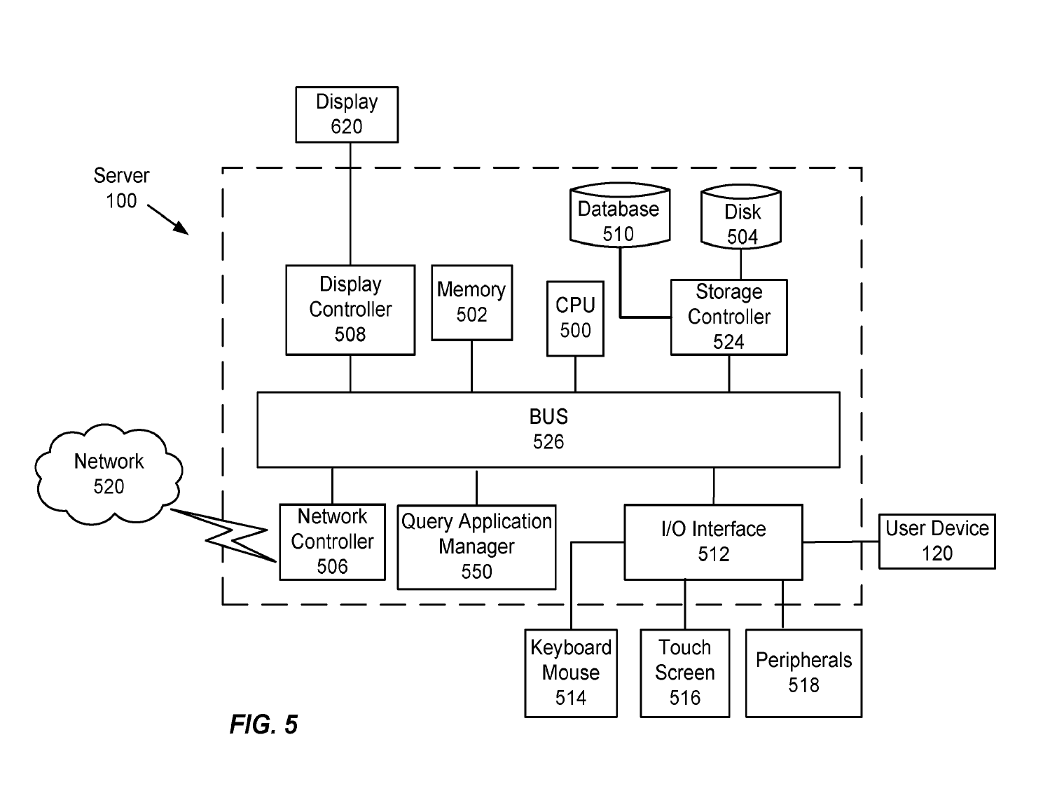

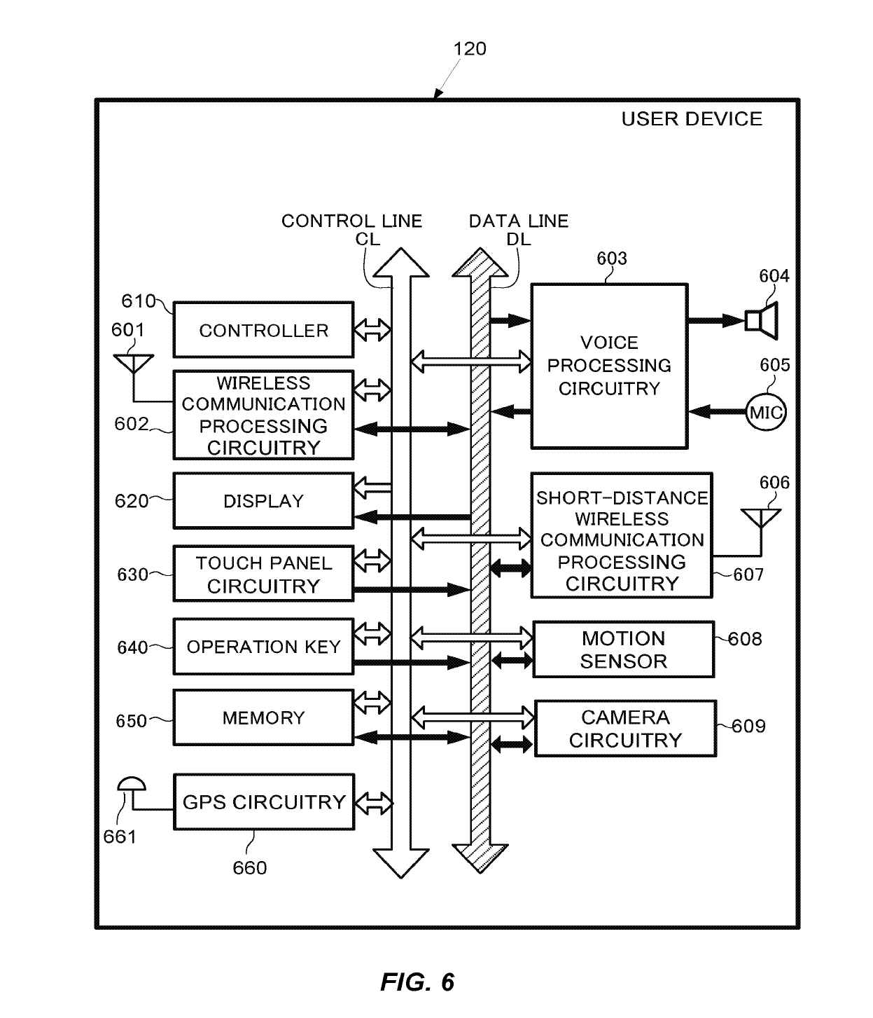

Each of the functions of the described embodiments may be implemented by one or more processing circuits or controller. A processing circuit includes a programmed processor (for example, controller 610 or a CPU 500), as a processor includes circuitry. A processing circuit may also include devices such as an application specific integrated circuit (ASIC) and conventional circuit components arranged to perform the recited functions. The processing circuit can be a part of the user device 120 or the server 100 as discussed in more detail with respect to FIGS. 5 and 6.

FIG. 5 is a detailed block diagram illustrating an exemplary server 100 according to certain embodiments of the present disclosure. In FIG. 5, the server 100 includes a CPU 500 which performs the processes described in the present disclosure. The process data and instructions may be stored in a memory 502. These processes and instructions (discussed with respect to FIGS. 2-3) may also be stored on a storage medium disk 504 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the server 100 communicates, such as a server or computer.

Further, the claimed advancements may be provided as a utility application, background daemon, or component of an operating system, or combination thereof, executing in conjunction with CPU 500 and an operating system such as Microsoft Windows, UNIX, Solaris, LINUX, Apple MAC-OS and other systems known to those skilled in the art.

The hardware elements in order to achieve the server 100 may be realized by various circuitry elements, known to those skilled in the art. For example, CPU 500 may be a Xenon or Core processor from Intel of America or an Opteron processor from AMD of America, or may be other processor types that would be recognized by one of ordinary skill in the art. In one embodiment, the CPU 500 may be implemented on an FPGA, ASIC, PLD or using discrete logic circuits, as one of ordinary skill in the art would recognize. Further, CPU 500 may be implemented as multiple processors cooperatively working in parallel to perform the instructions of the inventive processes described above with respect to FIGS. 2-3.

The server 100, in FIG. 5, also includes the network controller 506, such as an Intel Ethernet PRO network interface card from Intel Corporation of America, for interfacing with a network 520. As can be appreciated, the network 520 can be a public network, such as the Internet, or a private network such as an LAN or WAN network, or any combination thereof and can also include PSTN or ISDN sub-networks. The network 520 can also be wired, such as an Ethernet network, or can be wireless such as a cellular network including EDGE, 3G and 4G wireless cellular systems. The wireless network can also be WiFi, Bluetooth, or any other wireless form of communication that is known. The server 100 can communicate with external devices such as the user device 120 via the network controller 520.

The server 100 can further include a display controller 508, such as a NVIDIA GeForce GTX or Quadro graphics adaptor from NVIDIA Corporation of America for interfacing with display 620. The display 620 can be display of the user device 120. An I/O interface 512 interfaces with a keyboard and/or mouse 514 as well as a touch screen panel 516 on or separate from display 620. The I/O interface also connects to a variety of peripherals 518 including printers and scanners, such as an OfficeJet or DeskJet from Hewlett Packard. Further, the server 100 can be connected to the user device 120 via I/O interface 512 or through the network 520. The user device 120 can send queries that are handled by a query manager application 550 including extracting data from the disk 504 or the database 510 via the storage controller 524, from the memory 502, or trigger execution of processes discussed in FIGS. 2 and 3.

The storage controller 524 connects the storage medium disk 504 or the database 510 with communication bus 526, which may be an ISA, EISA, VESA, PCI, or similar, for interconnecting all of the components of the server 100. A description of the general features and functionality of the display 620, keyboard and/or mouse 514, as well as the display controller 508, storage controller 524, network controller 506, and the I/O interface 512 is omitted herein for brevity as these features are known.

FIG. 6 is a detailed block diagram illustrating an exemplary user device 120 according to certain embodiments of the present disclosure. In certain embodiments, the user device 120 may be a smartphone. However, the skilled artisan will appreciate that the features described herein may be adapted to be implemented on other devices (e.g., a laptop, a tablet, a server, an e-reader, a camera, a navigation device, etc.). The exemplary user device 120 includes a controller 610 and wireless communication processing circuitry 602 connected to an antenna 601. A speaker 604 and a microphone 605 are connected to voice processing circuitry 603.

The controller 610 and may include one or more Central Processing Units (CPUs), and may control each element in the user device 120 to perform functions related to communication control, audio signal processing, control for the audio signal processing, still and moving image processing and control, and other kinds of signal processing. The controller 610 may perform these functions by executing instructions stored in a memory 650. For example, the processes illustrated in FIGS. 2-3 may be stored in the memory 650 and executed based on the user inputs received via an interface such as screens 401, 402, and 403. Alternatively or in addition to the local storage of the memory 650, the functions may be executed using instructions stored on an external device such as the server 100 accessed on a network or on a non-transitory computer readable medium.

The memory 650 includes but is not limited to Read Only Memory (ROM), Random Access Memory (RAM), or a memory array including a combination of volatile and non-volatile memory units. The memory 650 may be utilized as working memory by the controller 610 while executing the processes and algorithms of the present disclosure. Additionally, the memory 650 may be used for long-term storage, e.g., of image data and information related thereto. The memory 650 may be configured to store the battle view information, operation view information and list of commands.

The user device 120 includes a control line CL and data line DL as internal communication bus lines. Control data to/from the controller 610 may be transmitted through the control line CL. The data line DL may be used for transmission of voice data, display data, etc.

The antenna 601 transmits/receives electromagnetic wave signals between base stations for performing radio-based communication, such as the various forms of cellular telephone communication. The wireless communication processing circuitry 602 controls the communication performed between the user device 120 and other external devices such as the server 100 via the antenna 601. The wireless communication processing circuitry 602 may control communication between base stations for cellular phone communication.

The speaker 604 emits an audio signal corresponding to audio data supplied from the voice processing circuitry 603. The microphone 605 detects surrounding audio and converts the detected audio into an audio signal. The audio signal may then be output to the voice processing circuitry 603 for further processing. The voice processing circuitry 603 demodulates and/or decodes the audio data read from the memory 650 or audio data received by the wireless communication processing circuitry 602 and/or a short-distance wireless communication processing circuitry 607. Additionally, the voice processing circuitry 603 may decode audio signals obtained by the microphone 605.

The exemplary user device 120 may also include a display 620, touch panel circuitry 630 (referred as touch panel 630 hereafter), an operation key 640, and short-distance communication processing circuitry 607 connected to an antenna 606. The display 620 may be a Liquid Crystal Display (LCD), an organic electroluminescence display panel, or another display screen technology. In addition to displaying still and moving image data, the display 620 may display operational inputs such as the item button 411, the rating button 413, the category button 415, the location button 417, the search button 419, the entity button 429, the item list button 423, the review button 427, the share button 429, the rating factor buttons 431, 433 and 435, and the rate button 437 in FIGS. 4A-4C, used for control of the user device 120. The display 620 may additionally display a GUI having multiple screens as shown in FIGS. 4A-4C, for a user to control aspects of the user device 120 and/or other devices. Further, the display 620 may display characters and images received by the user device 120 and/or stored in the memory 650 or accessed from an external device on a network such as a camera. For example, the user device 120 may access a network such as the Internet and display text and/or images transmitted from a Web server.

The touch panel 630 may include a physical touch panel display screen and a touch panel driver. The touch panel 630 may include one or more touch sensors for detecting an input operation on an operation surface of the touch panel display screen. The touch panel 630 also detects a touch shape and a touch area. Used herein, the phrase “touch operation” refers to an input operation performed by touching an operation surface of the touch panel display with an instruction object, such as a finger, thumb, or stylus-type instrument. In the case where a stylus or the like is used in a touch operation, the stylus may include a conductive material at least at the tip of the stylus such that the sensors included in the touch panel 630 may detect when the stylus approaches/contacts the operation surface of the touch panel display (similar to the case in which a finger is used for the touch operation).

In certain aspects of the present disclosure, the touch panel 630 may be disposed adjacent to the display 620 (e.g., laminated) or may be formed integrally with the display 620. For simplicity, the present disclosure assumes the touch panel 630 is formed integrally with the display 620 and therefore, examples discussed herein may describe touch operations being performed on the surface of the display 620 rather than the touch panel 630. However, the skilled artisan will appreciate that this is not limiting.

For simplicity, the present disclosure assumes the touch panel 630 is a capacitance-type touch panel technology. However, it should be appreciated that aspects of the present disclosure may easily be applied to other touch panel types (e.g., resistance-type touch panels) with alternate structures. In certain aspects of the present disclosure, the touch panel 630 may include transparent electrode touch sensors arranged in the X-Y direction on the surface of transparent sensor glass.

The touch panel driver may be included in the touch panel 630 for control processing related to the touch panel 630, such as scanning control. For example, the touch panel driver may scan each sensor in an electrostatic capacitance transparent electrode pattern in the X-direction and Y-direction and detect the electrostatic capacitance value of each sensor to determine when a touch operation is performed. The touch panel driver may output a coordinate and corresponding electrostatic capacitance value for each sensor. The touch panel driver may also output a sensor identifier that may be mapped to a coordinate on the touch panel display screen. Additionally, the touch panel driver and touch panel sensors may detect when an instruction object, such as a finger is within a predetermined distance from an operation surface of the touch panel display screen. That is, the instruction object does not necessarily need to directly contact the operation surface of the touch panel display screen for touch sensors to detect the instruction object and perform processing described herein. For example, in certain embodiments, the touch panel 630 may detect a position of a user's finger around an edge of the display panel 620 (e.g., gripping a protective case that surrounds the display/touch panel). Signals may be transmitted by the touch panel driver, e.g. in response to a detection of a touch operation, in response to a query from another element based on timed data exchange, etc.

The touch panel 630 and the display 620 may be surrounded by a protective casing, which may also enclose the other elements included in the user device 120. In certain embodiments, a position of the user's fingers on the protective casing (but not directly on the surface of the display 620) may be detected by the touch panel 630 sensors. Accordingly, the controller 610 may perform display control processing described herein based on the detected position of the user's fingers gripping the casing. For example, an element in an interface may be moved to a new location within the interface (e.g., closer to one or more of the fingers) based on the detected finger position.

Further, in certain embodiments, the controller 610 may be configured to detect which hand is holding the user device 120, based on the detected finger position. For example, the touch panel 630 sensors may detect a plurality of fingers on the left side of the user device 120 (e.g., on an edge of the display 620 or on the protective casing), and detect a single finger on the right side of the user device 120. In this exemplary scenario, the controller 610 may determine that the user is wearing the user device 120 with his/her right hand because the detected grip pattern corresponds to an expected pattern when the user device 120 is wearing only with the right hand.

The operation key 640 may include one or more buttons or similar external control elements, which may generate an operation signal based on a detected input by the user. In addition to outputs from the touch panel 630, these operation signals may be supplied to the controller 610 for performing related processing and control. In certain aspects of the present disclosure, the processing and/or functions associated with external buttons and the like may be performed by the controller 610 in response to an input operation on the touch panel 630 display screens rather than the external button, key, etc. In this way, external buttons on the user device 120 may be eliminated in lieu of performing inputs via touch operations, thereby improving water-tightness.

The antenna 606 may transmit/receive electromagnetic wave signals to/from other external apparatuses, and the short-distance wireless communication processing circuitry 607 may control the wireless communication performed between the other external apparatuses. Bluetooth, IEEE 802.11, and near-field communication (NFC) are non-limiting examples of wireless communication protocols that may be used for inter-device communication via the short-distance wireless communication processing circuitry 607.

The user device 120 may include a motion sensor 608. The motion sensor 608 may detect features of motion (i.e., one or more movements) of the user device 120. For example, the motion sensor 608 may include an accelerometer to detect acceleration, a gyroscope to detect angular velocity, a geomagnetic sensor to detect direction, a geo-location sensor to detect location, etc., or a combination thereof to detect motion of the user device 120. In certain embodiments, the motion sensor 608 may generate a detection signal that includes data representing the detected motion. For example, the motion sensor 608 may determine a number of distinct movements in a motion (e.g., from start of the series of movements to the stop, within a predetermined time interval, etc.), a number of physical shocks on the user device 120 (e.g., a jarring, hitting, etc., of the electronic device), a speed and/or acceleration of the motion (instantaneous and/or temporal), or other motion features. The detected motion features may be included in the generated detection signal. The detection signal may be transmitted, e.g., to the controller 610, whereby further processing may be performed based on data included in the detection signal. The motion sensor 608 can work in conjunction with Global Positioning System (GPS) circuitry 660.

The user device 120 may include camera circuitry 609, which includes a lens and shutter for capturing photographs of the surroundings around the user device 120. In an embodiment, the camera circuitry 609 captures surroundings of an opposite side of the user device 120 from the user. The images of the captured photographs can be displayed on the display panel 620. Memory circuitry saves the captured photographs. The memory circuitry may reside within the camera circuitry 609 or it may be part of the memory 650. The camera circuitry 609 can be a separate feature attached to the user device 120 or it can be a built-in camera feature. Furthermore, the camera circuitry 609 can be configured to detect features of motion (i.e., one or more movements) of the user device 120.

The RSS app executed on the user device 120 is an application that requests data processing from the server 100. The server 100, in FIG. 5, includes a storage controller 524 that manages the database on a disk 504 and the query application manager 550 that executes SQL (structured query language) statements against this data on the disk 504 or the database 510. The query application manager 550 also implements processing functions (e.g. query syntax analysis, optimization, and execution plan generation) as well as a simple network communication function to send and receive signal from a network controller 506.

In the above description, any processes, descriptions or blocks in flowcharts should be understood as representing modules, segments or portions of code which include one or more executable instructions for implementing specific logical functions or steps in the process, and alternate implementations are included within the scope of the exemplary embodiments of the present advancements in which functions can be executed out of order from that shown or discussed, including substantially concurrently or in reverse order, depending upon the functionality involved, as would be understood by those skilled in the art. The various elements, features, and processes described herein may be used independently of one another, or may be combined in various ways. All possible combinations and sub-combinations are intended to fall within the scope of this disclosure.

While certain embodiments have been described, these embodiments have been presented by way of example only, and are not intended to limit the scope of the present disclosures. Indeed, the novel methods, apparatuses and systems described herein can be embodied in a variety of other forms; furthermore, various omissions, substitutions and changes in the form of the methods, apparatuses and systems described herein can be made without departing from the spirit of the present disclosures. The accompanying claims and their equivalents are intended to cover such forms or modifications as would fall within the scope and spirit of the present disclosures. For example, this technology may be structured for cloud computing whereby a single function is shared and processed in collaboration among a plurality of apparatuses via a network.

The above disclosure also encompasses the embodiments noted below.

(1) A server including circuitry configured to receive, via a graphical user interface, a first item and a plurality of factors associated with the first item from an external device, prompt, via the graphical user interface, the external device to send a first set of factors selected from the plurality of factors, and a first set of ratings and a first set of weights corresponding to the first set of factors to indicate importance of each of the first set of factors in locating the first item, compute a first weighted rating based on the first set of ratings and the first set of weights assigned to the first set of factors to generate a threshold that captures the importance of each of the first set of factors, conduct a search in a database of the server based on the first weighted rating, the first set of ratings and the first set of weights associated with the first set of factors to locate at least one entity offering the first item, and transmit, via a network, the at least one entity to display on the external device to allow selection of an entity, from among the at least one entity, that exceeds the threshold of the importance of each of the first set of factors.
(2) The server of feature (1), in which each factor of the first set of factors is an attribute associated with the first item that influences selection of the at least one entity from the database of the server.
(3) The server of feature (1) and (2), in which each rating of the first set of ratings is a numerical value on a first numerical scale to assess a favorability of each factor of the first set of factors, where the favorability ranges from highly unfavorable to highly favorable corresponding to a first low value to a first high value of the first numerical scale.
(4) The server of feature (1) to (3), in which each weight of the first set of weights is a numerical value on a second numerical scale to assess importance of each of the first set of factors in selection of the at least one entity from the database of the server, where the importance varies from low importance to high importance corresponding to a second low value to a second high value of the second numerical scale.
(5) The server of feature (1) to (4), in which the first weighted rating is computed by aggregating for each factor of first set of factors a product of a rating of the first set of factor and a weight of the first set of weights corresponding to the each factor and dividing by an aggregate of each weight of the first set of weights.
(6) The server of feature (1), in which wherein the circuitry is further configured to compute an overall rating of the at least one entity based on a total number of reviews available for each of the first set of factors related to the first item.
(7) The server of feature (6), in which the circuitry is further configured to transmit, via the network, the overall rating of the at least one entity related to the first item to the external device to guide in selection of a first entity for purchasing the first item.
(8) The server of feature (6) and (7), in which the circuitry is further configured to prompt a social media search inquiry to the external device, via the graphical user interface, to receive at least one friend name from the external device.
(9) The server of feature (6) to (8), in which the circuitry is further configured to conduct a search in at least one social media to locate the first item reviewed by the at least one friend name.
(10) The server of feature (1), in which the circuitry is further configured to prompt a review inquiry to the external device, via the graphical user interface, to receive a second set of ratings and a second set of weights corresponding to a second set of factors selected from the plurality of factors associated with a second item upon purchase from a second entity.
(11) The server of feature (10), in which the circuitry is further configured compute a second weighted rating based on the second set of ratings and the second set of weights corresponding to the second set of factors.
(12) The server of feature (11), in which the circuitry is further configured to prompt the external device to receive a confirmation to post the second set of ratings and the second set of factors related to the second item purchased from the second entity on the at least one social media.
(13) A method including receiving, using processing circuitry, a first item and a plurality of factors associated with the first item from an external device, prompting, using the processing circuitry, the external device to send a first set of factors selected from the plurality of factors, and a first set of ratings and a first set of weights corresponding to the first set of factors to indicate importance of each of the first set of factors in locating the first item, computing, using the processing circuitry, a first weighted rating based on the first set of ratings and the first set of weights assigned to the first set of factors to generate a threshold that captures the importance of each of the first set of factors, conducting a search, using the processing circuitry, in a database of a server based on the first weighted rating, the first set of ratings and the first set of weights associated with the first set of factors to locate at least one entity offering the first item; and transmitting, via a network, the at least one entity to display on the external device to allow selection of an entity, from among the at least one entity, that exceeds the threshold of the importance of each of the first set of factors.
(14) The method of feature (13), in which each factor of the first set of factors is an attribute associated with the first item that influences selection of the at least one entity from the database of the server.
(15) The method of feature (13) and (14), in which each rating of the first set of ratings is a numerical value on a first numerical scale to assess a favorability of each factor of the first set of factors, where the favorability ranges from highly unfavorable to highly favorable corresponding to a first low value to a first high value of the first numerical scale.
(16) The method of feature (13) to (15), in which each weight of the first set of weights is a numerical value on a second numerical scale to assess importance of each of the first set of factors in selection of the at least one entity from the database of the server, where the importance varies from low importance to high importance corresponding to a second low value to a second high value of the second numerical scale.
(17) The method of feature (13) to (16), in which the first weighted rating is computed by aggregating for each factor of first set of factors a product of a rating of the first set of factor and a weight of the first set of weights corresponding to the each factor and dividing by an aggregate of each weight of the first set of weights.
(18) The method of feature (13), further comprising prompting, using the processing circuitry, a review inquiry to the external device to receive a second set of ratings and a second set of weights corresponding to a second set of factors selected from the plurality of factors associated with a second item upon purchase from a second entity.
(19) The method of feature (18), further comprising computing, using the processing circuitry, a second weighted rating based on the second set of ratings and the second set of weights corresponding to the second set of factors.
(20) A non-transitory computer-readable medium storing a program which when executed by a computer, causes the computer to perform a method, the method including receiving a first item and a plurality of factors associated with the first item from an external device, prompting the external device to send a first set of factors selected from the plurality of factors, and a first set of ratings and a first set of weights corresponding to the first set of factors to indicate importance of each of the first set of factors in locating the first item, computing a first weighted rating based on the first set of ratings and the first set of weights assigned to the first set of factors to generate a threshold that captures the importance of each of the first set of factors, conducting a search in a database of a server based on the first weighted rating, the first set of ratings and the first set of weights associated with the first set of factors to locate at least one entity offering the first item, and transmitting, via a network, the at least one entity to display on the external device to allow selection of an entity, from among the at least one entity, that exceeds the threshold of the importance of each of the first set of factors.

What is claimed is:

1. A server comprising:
circuitry configured to
receive, via a graphical user interface, a first item and a plurality of factors associated with the first item from an external device,
prompt, via the graphical user interface, the external device to send a first set of factors selected from the plurality of factors, and a first set of ratings and a first set of weights corresponding to the first set of factors to indicate importance of each of the first set of factors in locating the first item,
compute a first weighted rating based on the first set of ratings and the first set of weights assigned to the first set of factors to generate a threshold that captures the importance of each of the first set of factors,
conduct a search in a database of the server based on the first weighted rating, the first set of ratings and the first set of weights associated with the first set of factors to locate at least one entity offering the first item, and
transmit, via a network, the at least one entity to display on the external device to allow selection of an entity, from among the at least one entity, that exceeds the threshold of the importance of each of the first set of factors.

2. The server according to claim 1, wherein each factor of the first set of factors is an attribute associated with the first item that influences selection of the at least one entity from the database of the server.

3. The server according to claim 1, wherein each rating of the first set of ratings is a numerical value on a first numerical scale to assess a favorability of each factor of the first set of factors, where the favorability ranges from highly unfavorable to highly favorable corresponding to a first low value to a first high value of the first numerical scale.

4. The server according to claim 1, wherein each weight of the first set of weights is a numerical value on a second numerical scale to assess importance of each of the first set of factors in selection of the at least one entity from the database of the server, where the importance varies from low importance to high importance corresponding to a second low value to a second high value of the second numerical scale.

5. The server according to claim 1, wherein the first weighted rating is computed by aggregating for each factor of first set of factors a product of a rating of the first set of factor and a weight of the first set of weights corresponding to the each factor and dividing by an aggregate of each weight of the first set of weights.

6. The server according to claim 1, wherein the circuitry is further configured to compute an overall rating of the at least one entity based on a total number of reviews available for each of the first set of factors related to the first item.

7. The server according to claim 6, wherein the circuitry is further configured to transmit, via the network, the overall rating of the at least one entity related to the first item to the external device to guide in selection of a first entity for purchasing the first item.

8. The server according to claim 1, wherein the circuitry is further configured to prompt a social media search inquiry to the external device, via the graphical user interface, to receive at least one friend name from the external device.

9. The server according to claim 8, wherein the circuitry is further configured to conduct a search in at least one social media to locate the first item reviewed by the at least one friend name.

10. The server according to claim 1, wherein the circuitry is further configured to prompt a review inquiry to the external device, via the graphical user interface, to receive a second set of ratings and a second set of weights corresponding to a second set of factors selected from the plurality of factors associated with a second item upon purchase from a second entity.

11. The server according to claim 10, wherein the circuitry is further configured compute a second weighted rating based on the second set of ratings and the second set of weights corresponding to the second set of factors.

12. The server according to claim 11, wherein the circuitry is further configured to prompt the external device to receive a confirmation to post the second set of ratings and the second set of factors related to the second item purchased from the second entity on the at least one social media.

13. A method comprising:
receiving, using processing circuitry, a first item and a plurality of factors associated with the first item from an external device;
prompting, using the processing circuitry, the external device to send a first set of factors selected from the plurality of factors, and a first set of ratings and a first set of weights corresponding to the first set of factors to indicate importance of each of the first set of factors in locating the first item;
computing, using the processing circuitry, a first weighted rating based on the first set of ratings and the first set of weights assigned to the first set of factors to generate a threshold that captures the importance of each of the first set of factors;
conducting a search, using the processing circuitry, in a database of a server based on the first weighted rating, the first set of ratings and the first set of weights associated with the first set of factors to locate at least one entity offering the first item; and
transmitting, via a network, the at least one entity to display on the external device to allow selection of an entity, from among the at least one entity, that exceeds the threshold of the importance of each of the first set of factors.

14. The method according to claim 13, wherein each factor of the first set of factors is an attribute associated with the first item that influences selection of the at least one entity from the database of the server.

15. The method according to claim 13, wherein each rating of the first set of ratings is a numerical value on a first numerical scale to assess a favorability of each factor of the first set of factors, where the favorability ranges from highly unfavorable to highly favorable corresponding to a first low value to a first high value of the first numerical scale.

16. The method according to claim 13, wherein each weight of the first set of weights is a numerical value on a second numerical scale to assess importance of each of the first set of factors in selection of the at least one entity from the database of the server, where the importance varies from low importance to high importance corresponding to a second low value to a second high value of the second numerical scale.

17. The method according to claim 13, wherein the first weighted rating is computed by aggregating for each factor of first set of factors a product of a rating of the first set of factor and a weight of the first set of weights corresponding to the each factor and dividing by an aggregate of each weight of the first set of weights.

18. The method according to claim 13, further comprising prompting, using the processing circuitry, a review inquiry to the external device to receive a second set of ratings and a second set of weights corresponding to a second set of factors selected from the plurality of factors associated with a second item upon purchase from a second entity.

19. The method according to claim 18, further comprising computing, using the processing circuitry, a second weighted rating based on the second set of ratings and the second set of weights corresponding to the second set of factors.

20. A non-transitory computer-readable medium storing a program which when executed by a computer, causes the computer to perform a method, the method comprising:
receiving a first item and a plurality of factors associated with the first item from an external device;
prompting the external device to send a first set of factors selected from the plurality of factors, and a first set of ratings and a first set of weights corresponding to the first set of factors to indicate importance of each of the first set of factors in locating the first item;
computing a first weighted rating based on the first set of ratings and the first set of weights assigned to the first set of factors to generate a threshold that captures the importance of each of the first set of factors;
conducting a search in a database of a server based on the first weighted rating, the first set of ratings and the first set of weights associated with the first set of factors to locate at least one entity offering the first item; and
transmitting, via a network, the at least one entity to display on the external device to allow selection of an entity, from among the at least one entity, that exceeds the threshold of the importance of each of the first set of factors.
